(19) United States
(12) Patent Application Publication
(10) Pub. No.: US 2025/0238818 A1
(43) Pub. Date: Jul. 24, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Takuro MORI, Tokyo (JP)

(21) Appl. No.: 19/016,992

(22) Filed: Jan. 10, 2025

(30) Foreign Application Priority Data
Jan. 19, 2024 (JP) 2024-006993

(51) Int. Cl. G06Q 30/0201

(52) U.S. Cl. CPC G06Q 30/0201

(57) ABSTRACT

An information processing apparatus according to the present application includes a reception unit, an acquisition unit, an analysis unit, and a provision unit. The reception unit receives designation of a store or a facility. The acquisition unit acquires information concerning a plurality of users who have used the store or the facility, the designation of which has been received by the reception unit, the information indicating actions of the plurality of users before and after using the store or the facility. The analysis unit summarizes, based on the information indicating the actions of the plurality of users before and after using the store or the facility acquired by the acquisition unit, the actions of the plurality of users before and after using the store or the facility. The provision unit provides a summary result by the analysis unit.

### CROSS-REFERENCE TO RELATED APPLICATIONS

The present application claims priority to and incorporates by reference the entire contents of Japanese Patent Application No. 2024-006993 filed in Japan on Jan. 19, 2024.

### BACKGROUND OF THE INVENTION

### 1. Field of the Invention

The present invention relates to an information processing apparatus, an information processing method, and a non-transitory computer-readable storage medium.

### 2. Description of the Related Art

There has been known a technique for working out a sales strategy or the like in a store. For example, Japanese Patent Application Laid-open No. 2016-170778 proposes a technique for analyzing a trading area designated by a client device.

However, in the technology of the related art explained above, the analysis of the trading area can be performed but there is room for further improvement in order to support analyses of users of stores and facilities.

### SUMMARY OF THE INVENTION

An information processing apparatus according to the present application includes a reception unit, an acquisition unit, an analysis unit, and a provision unit. The reception unit receives designation of a store or a facility. The acquisition unit acquires information concerning a plurality of users who have used the store or the facility, the designation of which has been received by the reception unit, the information indicating actions of the plurality of users before and after using the store or the facility. The analysis unit summarizes, based on the information indicating the actions of the plurality of users before and after using the store or the facility acquired by the acquisition unit, the actions of the plurality of users before and after using the store or the facility. The provision unit provides a summary result by the analysis unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining information processing according to an embodiment;

FIG. 2 is a diagram illustrating an example of a configuration of an information processing system according to the embodiment;

FIG. 3 is a diagram illustrating an example of a configuration of an information processing apparatus according to the embodiment;

FIG. 4 is a diagram illustrating an example of a user information table stored in a user information storage unit of the information processing apparatus according to the embodiment;

FIG. 5 is a diagram illustrating an example of a location information table stored in a location information storage unit of the information processing apparatus according to the embodiment;

FIG. 6 is a diagram illustrating an example of a prompt used by an analysis unit of a processing unit in the information processing apparatus according to the embodiment;

FIG. 7 is a diagram illustrating another example of the prompt used by the analysis unit of the processing unit in the information processing apparatus according to the embodiment;

FIG. 8 is a diagram illustrating an example of map information provided by a provision unit of the processing unit in the information processing apparatus according to the embodiment and displayed on a terminal device;

FIG. 9 is a flowchart illustrating an example of information processing by the processing unit of the information processing apparatus according to the embodiment; and

FIG. 10 is a hardware configuration diagram illustrating an example of a computer that implements functions of the information processing apparatus according to the embodiment.

### DETAILED DESCRIPTION OF THE PREFERRED EMBODIMENTS

A mode (hereinafter referred to as “embodiment”) for implementing an information processing apparatus, an information processing method, and a non-transitory computer-readable storage medium according to the present application are explained in detail below with reference to the drawings. Note that the information processing apparatus, the information processing method, and the non-transitory computer-readable storage medium according to the present application are not limited by the embodiment. In addition, embodiments can be combined as appropriate within a range in which processing contents do not contradict one another. In the following embodiments, the same parts are denoted by the same reference numerals and signs, and redundant explanation is omitted.

### 1. Example of Information Processing

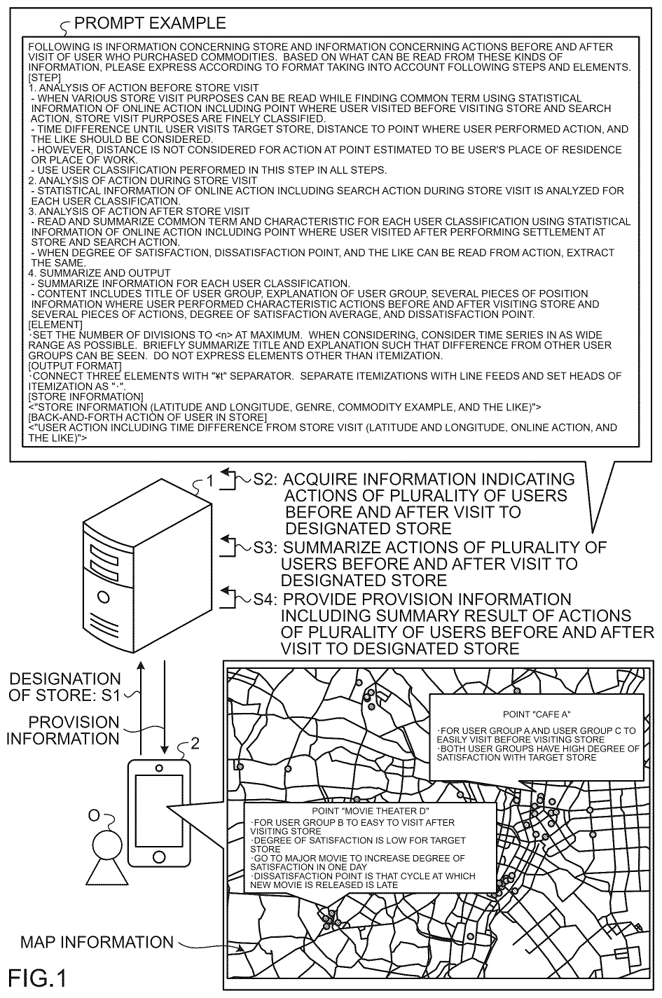

First, an example of information processing according to the embodiment is explained with reference to FIG. 1. FIG. 1 is a diagram for explaining information processing according to an embodiment.

An information processing apparatus 1 illustrated in FIG. 1 is an information processing apparatus that cooperates with a terminal device 2 of a service user O and provides various services to the service user O online and is implemented by, for example, one or more servers or a cloud system. The terminal device 2 is, for example, a smartphone, a tablet terminal, or a personal computer.

A service provided to the service user O by the information processing apparatus 1 is, for example, an action analysis service and, for example, map information in which information concerning a store or a facility designated by the service user O is arranged is transmitted to the terminal device 2 of the service user O. In the following explanation of steps S1 to S4, a case in which a target designated by the service user O is a store is mainly explained.

As illustrated in FIG. 1, the information processing apparatus 1 receives designation of a store by the service user O (step S1). The store is, for example, a retail store (for example, a convenience store, a general store, a clothing store, or a supermarket), an eating house (for example, a cafe, a restaurant, a fast food shop, or a tavern), or a service providing store (for example, a hair salon, a cleaning shop, or a beauty salon) but is not limited to such an example.

In step S1, for example, when receiving a summary information request including store information indicating the store designated by the service user O and transmitted from the terminal device 2, the information processing apparatus 1 receives designation of the store by the service user O based on the store information included in the summary information request. In the following explanation, the store designated in step S1 is sometimes described as designated store.

For example, the service user O operates the terminal device 2 to transmit a use request from the terminal device 2 to the information processing apparatus 1. The use request includes, for example, information indicating a position designated by the service user O or information indicating a region designated by the service user O. In the following explanation, a region including the position designated by the service user O or the region designated by the service user O is sometimes described as designated region.

When receiving the use request transmitted from the terminal device 2, the information processing apparatus 1 transmits store designation information including list information indicating a list of stores present in the designated region and map information of the designated region to the terminal device 2.

When receiving the store designation information transmitted from the information processing apparatus 1, the terminal device 2 displays list information indicating a list of stores present in the designated region and map information of the designated region based on the received store designation information. In the list information, stores present in the designated region are arranged to be individually designable. In the map information of the designated region, store figures indicating the positions of the stores present in the designated region are arranged to be individually designable on the map.

The service user O can designate a store set as an analysis target among a plurality of stores included in the list information displayed on the terminal device 2 and can designate a store figure corresponding to the store set as the analysis target among a plurality of store figures included in the map information displayed on the terminal device 2. When the service user O designates a store or a store figure, the terminal device 2 transmits, to the information processing apparatus 1, a summary information request including, as store information, information indicating the store designated by the service user O or information indicating a store corresponding to the store figure designated by the service user O.

Subsequently, the information processing apparatus 1 acquires information concerning a plurality of users who have visited the designated store, which is the store designated in step S1, the information indicating actions of the plurality of users before and after visiting the designated store (step S2). In the following explanation, a user of the designated store who has visited the designated store is sometimes described as store user.

The information indicating the action of the store user includes, for example, information indicating an online action of the store user and information indicating an offline action of the store user. The online action of the store user is, for example, an online search action (for example, web search) of the store user and online content browsing of the store user.

The online content is, for example, a blog article, a news article, video content, music content, or posted content to an SNS (Social Network Service) but is not limited to such an example.

The information indicating the offline action of the store user includes, for example, information indicating a facility or another store used by the store user and information indicating use content of the facility or the other store, information indicating means of transportation used by the store user and information indicating a section of the means transportation, and information indicating a moving route on which the store user has moved.

In step S2, the information processing apparatus 1 can also acquire information concerning a plurality of store users who have visited the designated store, the information indicating actions of the plurality of store users at the time of visiting the designated store.

The information indicating the actions of the store users at the time of visiting to the designated store is, for example, payment amounts and an average payment amount of the store users int the designated store, contents and genres of purchased commodities or purchased services of the store users in the designated store, and stay times and an average stay time of the store users in the designated store but is not limited to such an example. The payment amounts and the average payment amount of the store users are, for example, settlement amounts and an average settlement amount of the store users but is not limited to such an example.

In step S2, for example, the information processing apparatus 1 acquires, as the information indicating the actions of the plurality of store users before and after visiting to the designated store, information indicating actions of the plurality of store users until a predetermined period before visiting to the designated store and information indicating actions of the plurality of store users until a predetermined period after visiting to the designated store but is not limited to such an example.

In step S2, the information processing apparatus 1 can also acquire information concerning the designated store. The information of the designated store is information indicating the position of the designated store, information indicating a name of the designated store, information indicating a type of the designated store, information concerning commodities of the designated store, and the like. The information indicating the position of the designated store is, for example, information indicating the latitude and the longitude of the designated store.

The information indicating the name of the designated store includes information indicating a chain store name when the designated store is a chain store and includes information indicating a franchise store name when the designated store is a franchise store. The information indicating the type of the designated store is information indicating a genre of the store and is, for example, information indicating a genre such as a convenience store, a general store, a clothing store, a supermarket, a cafe, a restaurant, a fast food store, or a tavern. Note that the genre of the store may be a further subdivided genre. The information concerning the commodities and services of the designated store is information concerning commodities and services sold in the designated store.

The information processing apparatus 1 can acquire information indicating an action of a store user by limiting the information acquired in step S2 to information concerning a store user satisfying a specific condition. The specific condition is, for example, information set by the service user O. The information indicating the specific condition is included in, for example, the summary information request.

The specific condition is, for example, an attribute of the store user, a type of a place of sojourn of the store user, a facility used by the store user, means of transportation used by the store user, purchase of a specific commodity or use of a specific service of the store user in the designated store, and an average stay time of the store user in the designated store but is not limited to such an example. Note that the information processing apparatus 1 can also acquire information indicating an action of the store user by limiting the information acquired in step S2 to information in a specific time period designated by the service user O.

In step S2, the information processing apparatus 1 can acquire information indicating an attribute of each of the plurality of store users. The information indicating the attribute of the store user is a demographic attribute, a psychographic attribute, or the like of the store user. The demographic attribute is, for example, sex, age, a place of residence, a place of work, and an occupation. The psychographic attribute is an object of interest such as travel, clothes, cars, and religion, a lifestyle, an idea, a tendency of an idea, and the like.

Subsequently, the information processing apparatus 1 performs summary processing of summarizing the actions of the plurality of store users before and after visiting the designated store based on the information indicating the actions of the plurality of store users before and after visiting the designated store that is the information acquired in step S2 (step S3).

For example, the information processing apparatus 1 can summarize the actions of the plurality of store users by classifying the actions of the plurality of store users into two or more groups. For example, the information processing apparatus 1 classifies the actions of the plurality of store users into two or more groups based on characteristics of the actions of the store users before visiting the designated store and characteristics of the actions of the store users after visiting the designated store.

The characteristics of the actions of the store users before visiting the designated store are, for example, a characteristic that the store users sometimes use a specific facility or specific another store before visiting the designated store, a characteristic indicating a tendency of a use content in the facility or the store, a characteristic that the store users sometimes perform a specific search before visiting the designated store, and a characteristic indicating a tendency of posted content thereof but is not limited to such an example.

The characteristics of the actions of the store users after visiting the designated store is, for example, a characteristic that the store users sometimes use a specific facility or specific another store after visiting the designated store, a characteristic indicating a tendency of a use content in the facility or the store, a characteristic that the store user sometimes posts the designated store to the SNS after visiting the designated store, and a characteristic indicating a tendency of posted content but is not limited to such an example.

The information processing apparatus 1 can also determine a degree of satisfaction or a degree of dissatisfaction with the designated store as evaluation for the designated store based on the actions of the store users after visiting the designated store. For example, the information processing apparatus 1 determines the degree of satisfaction or the degree of dissatisfaction with the designated store based on content posted to the SNS for the designated store, content posted to the communication service, or the like. The information processing apparatus 1 can also determine the degree of satisfaction or the degree of dissatisfaction with the designated store based on, for example, word-of-mouth posting for the designated store to a word-of-mouth site. The information processing apparatus 1 can also determine a plurality of location users performing an action in common with a location user having a high degree of satisfaction or a location user having a low degree of dissatisfaction as location users having a high degree of satisfaction with the designated location or location users having a low degree of dissatisfaction with the designated location and determine a plurality of location users performing an action in common with a location user having a low degree of satisfaction or a location user having a high degree of dissatisfaction as location users having a low degree of satisfaction with the designated location or a location user having a high degree of dissatisfaction with the designated location.

For example, the information processing apparatus 1 determines the degree of satisfaction or the degree of dissatisfaction with the designated location based on a location user who has answered that the degree of satisfaction is high or the degree of dissatisfaction is low in a questionnaire or the like as a location user who has a high degree of satisfaction with the designated location or a location user who has a low degree of dissatisfaction in a questionnaire or the like, and a location user who has answered that the degree of satisfaction is low or the degree of dissatisfaction is high in a questionnaire or the like as a location user who has a low degree of satisfaction with the designated location or a location user who has a high degree of dissatisfaction with the designated location.

When the information acquired in step S2 includes the information indicating the actions of the plurality of store users at the time of visiting to the designated store, the information processing apparatus 1 can summarize actions of the plurality of store users before, during, and after visiting to the designated store based on the information indicating the actions of the plurality of store users before and after visiting to the designated store and the information indicating the actions of the plurality of store users at the time of visiting to the designated store.

For example, the information processing apparatus 1 classifies the actions of the plurality of store users into two or more groups based on characteristics of the actions of the store users before visiting the designated store, characteristics of the actions of the store users when visiting the designated store (during the visiting), and characteristics of the actions of the store users after visiting the designated store.

The characteristics of the action of the store user after visiting the designated store include, but are not limited to, a characteristic that, for example, an average stay time of the store users in the designated store is short or long, a characteristic that, for example, an average moving distance of the store users in the designated store, and a characteristic that, for example, an average payment amount of the store users in the designated store is small or large.

The information processing apparatus 1 can also classify the actions of the plurality of store users into two or more groups for each of the characteristics of the actions of the store users before visiting the designated store, the characteristics of the actions of the store users when visiting the designated store (during the visiting), and the characteristics of the actions of the store users after visiting the designated store.

The information processing apparatus 1 performs the summary processing explained above using generative AI (Artificial Intelligence). The generative AI is, for example, text generation AI. The text generative AI is, for example, a large-scale language model learned to estimate and output the next token from an input token string and is, for example, a transformer-based model or an RNN (Recurrent Neural Network)-based model but may be a mixed model of these models or the like. The text generative AI may be a composite system combined with an identification machine or the like for preventing unauthorized use.

The transformer-based model is, for example, GPT (Generative Pre-trained Transformer) (registered trademark), PaLM2 (Pathways Language Model Version 2), or LLaMA (Large Language Model Meta AI) but is not limited to such an example. The RNN-based model is, for example, an RWKV (Receptance Weighted Key Value) but is not limited to such an example.

Note that the generative AI is desirably learned not to include personal information and the like in a generation result of the generative AI. The generative AI is disposed in an external information processing apparatus. The information processing apparatus 1 uses the generative AI via an API (Application Programming Interface). However, the generative AI may be disposed in the information processing apparatus 1.

Input information input to the generative AI is referred to as prompt. In the following explanation, the input information input to the generative AI is sometimes described as prompt. The prompt is, for example, information indicating an instruction, a request, or the like given to a language model in order to execute a specific task for the generative AI.

For example, the information processing apparatus 1 inputs, to the generative AI, a prompt including instruction information that is information for instructing a summary of the actions of the plurality of store users before and after visiting the designated store and a part or all of the information acquired in step S1 and causes the generative AI to output a summary result of the actions of the plurality of store users before and after visiting the designated store.

In addition, for example, the information processing apparatus 1 inputs, to the generative AI, a prompt including instruction information that is information for instructing a summary of the actions of the plurality of store users before visiting to the designated store and a part or all of the information acquired in step S1 and causes the generative AI to output a summary result of the actions of the plurality of store users before visiting to the designated store. The actions before and after visiting the designated store are an action before visiting the designated store, an action at the time of visiting the designated store (during the visiting), and an action after visiting the designated store.

For example, the information processing apparatus 1 can cause the generative AI to output a summary result of the actions of the plurality of store users before and after visiting the designated store by including, in the prompt, instruction information for instructing a summary of the actions of the plurality of store users by classifying the actions of the plurality of store users before and after visiting the designated store into a plurality of groups.

For example, the information processing apparatus 1 can cause the generative AI to output a summary result of the actions of the plurality of store users before and after visiting the designated store by including instruction information including, in the prompt, information indicating an example of the characteristics of the actions of the plurality of store users before and after visiting the designated store.

For example, the information processing apparatus 1 can cause the generative AI to output a summary result of the actions of the plurality of store users before and after visiting the designated store by including, in the prompt, instruction information including information for clearly indicating characteristics that are targets of being summarized as characteristics of the actions of the plurality of store users before and after visiting the designated store.

The characteristics of the actions of the store users before visiting the designated store are, for example, a characteristic that the store users sometimes use a specific facility or specific another store before visiting the designated store, a characteristic indicating a tendency of a use content in the facility or the store, a characteristic that the store users sometimes perform a specific search before visiting the designated store, and a characteristic indicating a tendency of posted content thereof but is not limited to such an example.

The characteristics of the actions of the store users after visiting the designated store is, for example, a characteristic that the store users sometimes use a specific facility or specific another store after visiting the designated store, a characteristic indicating a tendency of a use content in the facility or the store, a characteristic that the store user sometimes posts the designated store to the SNS after visiting the designated store, and a characteristic indicating a tendency of posted content but is not limited to such an example.

The information indicating the actions of the store users at the time of visiting to the designated store is, for example, payment amounts and an average payment amount of the store users int the designated store, contents and genres of purchased commodities or purchased services of the store users in the designated store, and stay times and an average stay time of the store users in the designated store but is not limited to such an example.

For example, the information processing apparatus 1 inputs a prompt illustrated in FIG. 1 to the generative AI and causes the generative AI to output a summary result of the actions of the plurality of store users before and after visiting the designated store. The prompt illustrated in FIG. 1 includes instruction information and information necessary for summary processing. The instruction information also includes information concerning an output format that defines how to output the characteristics of the actions of the plurality of store users before and after visiting the store. In the example illustrated in FIG. 1, information concerning the designated store and information concerning the actions of the store users before and after visiting the store are included as the information necessary for the summary processing.

The information processing apparatus 1 can classify the actions of the plurality of store users into two or more groups by using a classification model instead of using the generative AI. The classification model is, for example, a GBDT (Gradient Boosting Decision Tree), a neural network, or the like, but is not limited to such an example.

The generative AI may be multi-modal generative AI or the like. The multi-modal generative AI is, for example, generative AI that generates at least one of text, an image, and voice from at least one of text, an image, and voice. The multi-modal generative AI is, for example, GPT-4 Turbo with vision, gemini, CM3Leon (Chameleon Multimodal Model), or the like but is not limited to such an example.

Subsequently, the information processing apparatus 1 provides provision information including the information indicating the result of the summary processing in step S3 to the service user O (step S4). For example, the information processing apparatus 1 provides the provision information to the service user O by transmitting the provision information including the information indicating the result of the summary processing in step S3 to the terminal device 2. For example, the information processing apparatus 1 provides information indicating characteristics of the two or more groups classified in step S3.

For example, the information processing apparatus 1 provides map information showing the result of the summary processing in step S3 on a map to the service user O as the provision information. The result of the summary processing shown on the map includes, for example, information indicating characteristics of the classified groups. For example, when the information indicating the characteristics of the groups includes information indicating points for the store users to easy to visit, in the map information provided as the provision information, information emphasizing the points for the store users to easy to visit is shown on the map in addition to the information indicating the characteristics of the groups.

In the example illustrated in FIG. 1, as a result of the summary processing in step S3, information concerning a “cafe A” serving as a point for the store users to easy to visit before visiting to the designated store is indicated and information concerning a “movie theater D” serving as a point for the store users to easy to visit after visiting to the designated store is indicated.

In the example explained above, the information processing apparatus 1 receives designation of a store in step S1 but can also receive designation of a facility instead of the store. The facility is, for example, a commercial facility (including a commercial complex), a movie theater, a sports gym, a hospital, a library, a school, or a public facility but is not limited to such an example.

In this case, in step S2, the information processing apparatus 1 acquires information concerning a plurality of facility users who are a plurality of users who have used the designated facility that is the facility, the designation has been received in step S1, the information indicating actions of the plurality of facility users before and after using the designated facility (or before, during, and after use). Before, during, and after using the designated facility means before the use of the designated facility, during the use of the designated facility, or after the use of the designated facility. The information indicating the actions of the users who use the facility is information similar to the information indicating the actions of the store users explained above.

In step S3, the information processing apparatus 1 performs the summary processing of summarizing the actions of the plurality of facility users before and after use (or before and after use) of the designated facility based on the information indicating the actions of the plurality of facility users before and after use (or before and after use) of the designated facility that is the information acquired in step S2. A method of the summary processing for the actions of the plurality of facility users is similar to the method of the summary processing for the actions of the plurality of store users.

Note that, based on the information indicating the actions of the plurality of users before and after use (or before, during, and after use) of the store or the facility, the information processing apparatus 1 can classify intentions and purposes of using the store or the facility instead of or in addition to the characteristics before and after use (or before, during, and after use) of the store or the facility of the user.

As explained above, the information processing apparatus 1 receives designation of a store or a facility, acquires information indicating actions of the plurality of users before and after using the store or the facility, the information being information of the plurality of users who have used the store or the facility, the designation of which has been received, summarizes the actions of the plurality of users before and after using the store or the facility based on the acquired information indicating actions of the plurality of users before and after using the store or the facility, and provides a summarized result.

Accordingly, the information processing apparatus 1 can support an operation strategy in the store or the facility. For example, the service user O can plan an operation strategy of the designated store or the designated facility from the actions of the store users before and after using the designated store or the designated facility based on the result of summarizing the actions of the plurality of store users before and after using the designated store or the designated facility.

For example, the service user O can efficiently distribute an advertisement of the designated store or the designated facility by providing advertisement content to other stores or facilities where the store users or the facility users frequently visit before and after using the designated store or the designated facility.

When the service user O goes to another store or another facility of the same genre as the designated store or the designated facility after using the designated store or the designated facility, it is possible to grasp that there is a high possibility that the store user or the facility user is dissatisfied. In the opposite case, the service user O can grasp that there is high possibility that the service user O is dissatisfied with the other store or the other facility.

In the following explanation, a configuration and the like of an information processing system including the information processing apparatus 1 and the terminal device 2 that perform the processing explained above are explained in detail.

### [2. Configuration of the Information Processing System]

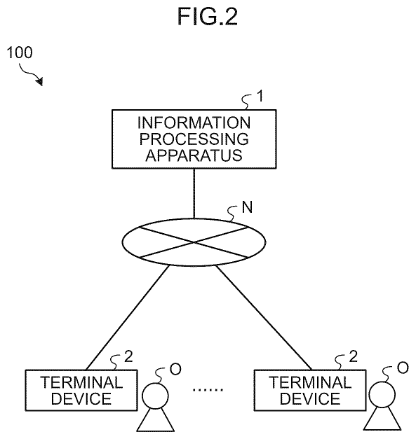

FIG. 2 is a diagram illustrating an example of a configuration of an information processing system according to the embodiment. As illustrated in FIG. 2, an information processing system 100 according to the embodiment includes the information processing apparatus 1 and a plurality of terminal devices 2.

The plurality of terminal devices 2 are used by different service users O. The terminal devices 2 are, for example, notebook PCs (Personal Computers), desktop PCs, smartphones, tablet PCs, or wearable devices. The wearable devices are, for example, smart glasses, smart watches, or the like but are not limited to such an example.

The information processing apparatus 1 and each of the terminal devices 2 are communicably connected to each other by wire or radio via a network N. Note that the information processing system 100 illustrated in FIG. 2 may include a plurality of information processing apparatuses 1 and the like.

The network N includes, for example, a WAN (Wide Area Network) such as the Internet and a mobile communication network such as LTE (Long Term Evolution), 4G (4th Generation), or 5G (5th Generation) but is not limited to such an example.

The terminal device 2 is connected to the network N via short-range wireless communication such as a mobile communication network, Bluetooth (registered trademark), or a LAN (Local Area Network) and can communicate with the information processing apparatus 1 and the like.

### [3. Configuration of the Information Processing Apparatus 1]

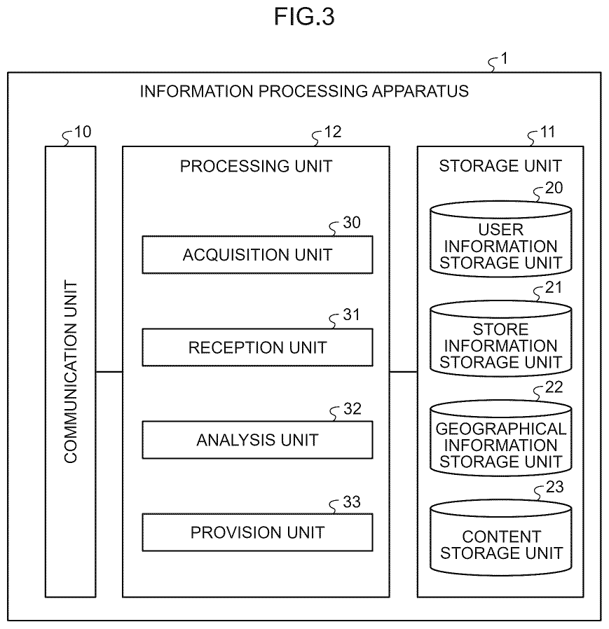

FIG. 3 is a diagram illustrating an example of a configuration of the information processing apparatus 1 according to the embodiment. As illustrated in FIG. 3, the information processing apparatus 1 includes a communication unit 10, a storage unit 11, and a processing unit 12.

### [3.1. Communication Unit 10]

The communication unit 10 is implemented by, for example, a communication module, a NIC (Network Interface Card), or the like. Then, the communication unit 10 is connected to the network N by wire or radio and transmits and receives information to and from various other devices. For example, the communication unit 10 transmits and receives information to and from the terminal device 2 via the network N.

### [3.2. Storage Unit 11]

The storage unit 11 is implemented by, for example, a semiconductor memory element such as a RAM (Random Access Memory) or a flash memory or a storage device such as a hard disk or an optical disk. The storage unit 11 includes a user information storage unit 20, a location information storage unit 21, a geographical information storage unit 22, and a content storage unit 23.

### [3.2.1. User Information Storage Unit 20]

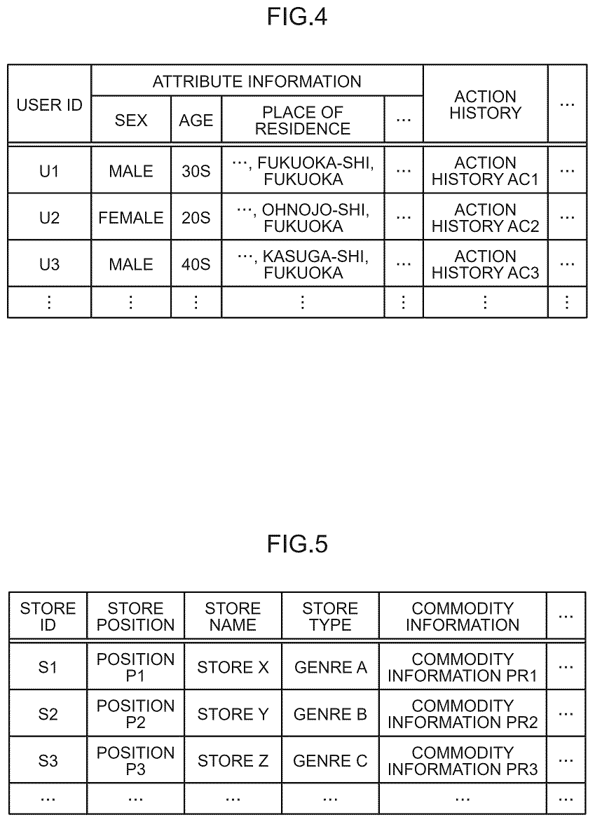

The user information storage unit 20 stores user information including information concerning a user. FIG. 4 is a diagram illustrating an example of a user information table stored in the user information storage unit 20 of the information processing apparatus 1 according to the embodiment. As illustrated in FIG. 4, the user information table stored in the user information storage unit 20 includes items such as a “user ID”, “attribute information”, and “action history”.

The “user ID” is identification information for identifying a user. The “attribute information” is attribute information of the user corresponding to the “user ID” and includes, for example, information of a psychographic attribute, information of a demographic attribute, and the like. The demographic attribute is, for example, sex, age, a place of residence, a place of work, and an occupation. The psychographic attribute is an object of interest such as travel, clothes, cars, and religion, a lifestyle, an idea, a tendency of an idea, and the like.

The “action history” is information indicating an action history of the user corresponding to the “user ID” and is, for example, information indicating a position history of the user, information indicating a use history of stores and facilities of the user, information indicating a use history of means of transportation of the user, and the like but is not limited to such an example.

The information indicating the use history of stores and facilities of the user is, for example, payment amounts and an average payment amount of the user in the stores or the facilities, contents and genres of purchased commodities or purchased services of the user in the stores and the facilities, stay times and an average stay time of the user in the stores or the facilities, and the like but is not limited to such an example.

### [3.2.2. Location Information Storage Unit 21]

The location information storage unit 21 stores information of various locations (for example, stores and facilities). FIG. 5 is a diagram illustrating an example of a location information table stored in the location information storage unit 21 of the information processing apparatus 1 according to the embodiment. As illustrated in FIG. 5, the location information table stored in the location information storage unit 21 includes items such as a “location ID”, a “location position”, a “location name”, a “location type”, and “location information”.

The “location ID” is identification information for identifying a location such as a store or a facility. The “place position” is information indicating a position of a location corresponding to the “location ID” and is, for example, information indicating the latitude and the longitude of the location. The “location name” is information indicating a name of the location corresponding to the “location ID”. When the location is a store and when the store is a chain store, the “location name” includes information indicating a chain store name. When the store is a chain store, the “location name” includes information indicating a franchise store name.

The “location type” is information indicating a type of the location corresponding to the “location ID” and is, for example, information indicating a genre of the location. The “location information” is information concerning the location corresponding to the “location ID”. For example, when the location is a store, the “location information” is information concerning commodities and services. When the location is a facility, the “location information” is information indicating objects and services provided in the facility.

Note that, although not illustrated, the location information storage unit 21 may include information indicating sales of the location, information indicating the area of the location, and information indicating the number of employees in the location.

### [3.2.3. Geographical Information Storage Unit 22]

The geographical information storage unit 22 stores geographical information. The geographical information is, for example, information indicating topography, information indicating passages, information indicating public institution routes, information indicating traffic regulations and signs, information of news articles, information concerning disasters, information of facilities and stores, and weather information but is not limited to such an example.

### [3.2.4. Content Storage Unit 23]

The content storage unit 23 stores various contents. The contents stored in the content storage unit 23 are, for example, information indicating news articles, posted information to an SNS concerning stores, posted information to a communication service concerning stores, word-of-mouth posting for stores to a word-of-mouth site, advertisement information of stores, and weather information but is not limited to such an example.

### [3.3. Processing Unit 12]

The processing unit 12 is a controller and is implemented by, for example, a processor such as a CPU (Central Processing Unit) or an MPU (Micro Processing Unit) executing various programs (equivalent to an example of an information processing program) stored in a storage device inside the information processing apparatus 1 using a RAM or the like as a work region.

The processing unit 12 is a controller and a part or the entire processing unit 12 may be implemented by an integrated circuit such as an ASIC (Application Specific Integrated Circuit), an FPGA (Field Programmable Gate Array), or a GPGPU (General Purpose Graphic Processing Unit).

As illustrated in FIG. 3, the processing unit 12 includes a reception unit 30, an acquisition unit 31, an analysis unit 32, and a provision unit 33, and implements or executes functions and action of information processing explained below. Note that the internal configuration of the processing unit 12 is not limited to the configuration illustrated in FIG. 3 and may be another configuration if the configuration is a configuration for performing information processing explained.

### [3.3.1. Reception Unit 30]

The reception unit 30 receives various kinds of information. For example, the reception unit 30 receives a use request transmitted from the terminal device 2. The use request includes, for example, information indicating a position designated by the service user O or information indicating a designated region which is a region designated by the service user O.

The reception unit 30 receives designation of a store or a facility. For example, the reception unit 30 receives the designation of the store or the facility by the service user O by receiving a summary information request including information indicating the designation of the store or the facility by the service user O and transmitted from the terminal device 2.

### [3.3.2. Acquisition Unit 31]

The acquisition unit 31 acquires various kinds of information from an external information processing apparatus, the terminal device 2, and the like via the network N and the communication unit 10.

For example, the acquisition unit 31 acquires user information from the external information processing apparatus and causes the user information storage unit 20 to store the acquired user information. The acquisition unit 31 acquires information concerning a store or a facility from the external information processing apparatus and causes the location information storage unit 21 to store the acquired information concerning the store or the facility.

The acquisition unit 31 acquires geographical information from the external information processing apparatus and causes the geographical information storage unit 22 to store the acquired geographical information. The acquisition unit 31 acquires various contents from the external information processing apparatus and causes the content storage unit 23 to store the acquired various contents.

The acquisition unit 31 acquires various kinds of information from the storage unit 11. For example, the acquisition unit 31 acquires user information from the user information storage unit 20 and acquires information concerning a store or a facility from the location information storage unit 21. The acquisition unit 31 acquires geographical information from the geographical information storage unit 22. The acquisition unit 31 acquires content from the content storage unit 23.

For example, when designation of a store or a facility is received by the reception unit 30, the acquisition unit 31 acquires information concerning a plurality of users who have used the designated facility or the designated facility which is the store or the facility, the designation of which has been received by the reception unit 30, the information indicating actions of the plurality of users before and after using the designated facility or the designated facility.

When the designation of the store or the facility is received by the reception unit 30, the acquisition unit 31 can further acquire information concerning the designated facility or a plurality of users who have used the designated facility, the information indicating actions of the plurality of users at the time of using the designated facility or the designated facility.

The information indicating the action of the location user includes, for example, information indicating an online action of the location user and information indicating an offline action of the location user. The online action of the location user is, for example, an online search action (for example, web search) of the location user and online content browsing of the location user.

The online content is, for example, a blog article, a news article, video content, music content, a posted content to an SNS, or a posted content to a word-of-mouth site but is not limited to such an example.

The information indicating the offline action of the location user includes, for example, information indicating another location (another store or another facility) used by the location user, information indicating usage content of the location user, information indicating means of transportation used by the location user and information indicating a section of the means of transportation, and information indicating a moving route on which the location user has moved.

The acquisition unit 31 can also acquire information concerning a plurality of location users who have used a designated location, the information indicating action of the plurality of location users at the time of using the designated location. The use of the designated location is, when the designated location is a store, a visit to the store, purchase of a commodity and a service in the store, or the like and is, when the designated location is a facility, a visit to the facility, use of equipment and a service in the facility, or the like but is not limited to such an example.

The information indicating the actions of the location users at the time of using the designated location is, for example, payment amounts and an average payment amount of the location users at the designated location, contents and genres of purchased commodities or purchased services of the location users at the designated location, and stay times and an average stay time of the location users at the designated location but is not limited to such an example. The payment amounts and the average payment amount of the location users is, for example, settlement amounts and an average settlement amount of the location users but is not limited to such an example.

For example, the acquisition unit 31 acquires, as the information indicating the actions of the plurality of location users before and after using the designated location, information indicating actions of the plurality of location users until a predetermined period before the use of the designated location and information indicating actions of the plurality of location users until a predetermined period after using the designated location but is not limited to such an example.

The acquisition unit 31 can also acquire information concerning the designated location. The information concerning the designated location includes information indicating the position of the designated location, information indicating a name of the designated location, information indicating a type of the designated location, information concerning a commodity in the designated location, and the like. The information indicating the position of the designated location is, for example, information indicating the latitude and longitude of the designated location.

The information indicating the name of the designated location includes information indicating a chain store name when the designated location is a store and when the designated store is a chain store and includes information indicating a franchise store name when the designated store is a franchise store. The information indicating the type of the designated location is information indicating a genre of the location and is, for example, information indicating a genre such as a convenience store, a general store, a clothing store, a supermarket, a cafe, a restaurant, a fast food store, or a tavern. Note that the genre of the store may be a further subdivided genre. The information concerning the commodity and the service at the designated location is information concerning commodities and services sold at the designated location.

The acquisition unit 31 can acquire information indicating an action of the store user while limiting the information to information of the store user satisfying a specific condition. The specific condition is, for example, information set by the service user O. The information indicating the specific condition is included in, for example, the summary information request.

The specific condition is, for example, an attribute of the location user, a type of a place of sojourn of the location user, another location (another store or another facility) used by the location user, means of transportation used by the location user, purchase of a specific product or use of a specific service of the location user at the designated location, and an average stay time of the location user at the designated location but is not limited to such an example. Note that the acquisition unit 31 can also acquire the information indicating the action of the store user while limiting the information to information in a specific time period designated by the service user O.

The acquisition unit 31 can also acquire information indicating an attribute of each of the plurality of location users. The information indicating the attribute of the location user is a demographic attribute, a psychographic attribute, or the like of the location user. The demographic attribute is, for example, sex, age, a place of residence, a place of work, and an occupation. The psychographic attribute is an object of interest such as travel, clothes, cars, and religion, a lifestyle, an idea, a tendency of an idea, and the like.

### [3.3.3. Analysis Unit 32]

The analysis unit 32 summarizes the actions of the plurality of users before and after using the designated store or the designated facility based on the information indicating the actions of the plurality of users before and after using the designated store or the designated facility acquired by the acquisition unit 31. In the following explanation, the designated store or the designated facility are sometimes described as designated location and the user of the designated store or the designated facility is sometimes described as location user.

For example, the analysis unit 32 can summarize the actions of the plurality of location users by classifying the actions of the plurality of location users into two or more groups. For example, the analysis unit 32 classifies the actions of the plurality of location users into two or more groups based on characteristics of the action of the location user before using the designated location and characteristics of the action of the location user after using the designated location.

The characteristics of the action of the location user before using the designated store are, for example, a characteristic that the location user sometimes uses a specific facility or specific another store before using the designated location, a characteristic indicating a tendency of use content in the facility or the store, a characteristic that the location user sometimes performs a specific search before using the designated location, and a characteristic indicating a tendency of posted content thereof but is not limited to such an example.

The characteristics of the action of the location user after using the designated location are, for example, a characteristic that the location user sometimes uses a specific facility or a specific other store after using the designated location, a characteristic indicating a tendency of use content in the facility or the store, a characteristic that the location user sometimes post the designated location to an SNS after using the designated location, or a characteristic indicating a tendency of post content thereof but is not limited to such an example.

The analysis unit 32 can also determine a degree of satisfaction or a degree of dissatisfaction with the designated location as an evaluation for the designated store based on the action of the location user after using the designated location. For example, the analysis unit 32 determines a degree of satisfaction or a degree of dissatisfaction with the designated location based on posted content to the SNS for the designated store, posted content in the communication service, or the like. The analysis unit 32 can also determine a degree of satisfaction or a degree of dissatisfaction with the designated store based on, for example, word-of-mouth posting for the designated store to a word-of-mouth site.

The analysis unit 32 can also determine a plurality of location users who perform actions common to a location user having a high degree of satisfaction or a location user having a low degree of dissatisfaction as location users having a high degree of satisfaction with the designated location or location users having a low degree of dissatisfaction with the designated location and determine a plurality of location users who perform actions common to a location user having a low degree of satisfaction or a location user having a high degree of dissatisfaction as location users having a low degree of satisfaction with the designated location or location users having a high degree of dissatisfaction with the designated location.

For example, the analysis unit 32 sets a location user who has answered that a degree off satisfaction is high or a degree of dissatisfaction is low in a questionnaire or the like as a location user having a high degree of satisfaction with the designated location or a location user having a low degree of dissatisfaction with the designated location and sets a location user who has answered that a degree of satisfaction is low or a degree of dissatisfaction is higher as a location user having a low degree of satisfaction with the designated location or a location user having a high degree of dissatisfaction with the designated location and determines a degree of satisfaction with the designated location based on these location users.

When the information acquired by the acquisition unit 31 includes information indicating actions of the plurality of location users at the time of using the designated location, the analysis unit 32 can summarize the actions of the plurality of location users before, during, and after using the designated store based on the information indicating the actions of the plurality of location users before and after using the designated location and the information indicating the actions of the plurality of location users at the time of using the designated location.

For example, the analysis unit 32 classifies the actions of the plurality of location users into two or more groups based on characteristics of the actions of the location users before using the designated location, characteristics of the actions of the location users at the time of use (during the use) of the designated location, and characteristics of the actions of the location users after using the designated location.

The characteristics of the actions of the location users after using the designated location are, for example, a characteristic that, for example, an average stay time at the designated location of the location users is short or long, a characteristic that, for example, an average moving distance at the designated location of the location users is short or long, and a characteristics that, for example, an average payment amount at the designated location of the location users is small or large but are not limited to such an example.

The analysis unit 32 can also classify the actions of the plurality of store users into two or more groups for each of characteristics of the actions of the store users before visiting the designated store, characteristics of the actions of the store users when visiting the designated store (during the visiting), and characteristics of the actions of the store users after visiting the designated store.

The analysis unit 32 performs the summary processing explained above using generative AI. The generative AI is, for example, text generation AI. The text generative AI is, for example, a large-scale language model learned to estimate and output the next token from an input token string and is, for example, a transformer-based model or an RNN-based model but may be a mixed model these models. The text generative AI may be a composite system combined with an identification machine or the like for preventing unauthorized use.

The transformer-based model is, for example, GPT, PaLM2, or LLaMA but is not limited to such an example. The RNN-based model is, for example, RWKV but is not limited to such an example.

Note that the generative AI is desirably learned not to include personal information and the like in a generation result of the generative AI. The generative AI is disposed in an external information processing apparatus and the analysis unit 32 uses the generative AI via an API. However, the generative AI may be disposed in the information processing apparatus 1.

Input information input to the generative AI is referred to as prompt. In the following explanation, the input information input to the generative AI is sometimes described as prompt. The prompt is, for example, information indicating an instruction, a request, or the like given to the generative AI in order to execute a specific task for the generative AI.

The analysis unit 32 inputs, to the generative AI, a prompt including, for example, instruction information that is information for instructing a summary of the actions of the plurality of location users before and after using the designated location and a part or all of the information acquired by the acquisition unit 31 and causes the generative AI to output a summary result of the actions of the plurality of location users before and after using the designated location.

The analysis unit 32 inputs, to the generative AI, for example, a prompt including instruction information including information for instructing a summary of the actions of the plurality of location users before and after using the designated location and a part or all of the information acquired in step S1 and causes the generative AI to output a summary result of the actions of the plurality of location users before and after using the designated location. The actions before and after the use of the designated location are an action before the use of the designated location, an action at the time of use (during the use) of the designated location, and an action after the use of the designated location.

The instruction information includes, for example, information for instructing an action analysis before the use of the designated location of the location user, information for instructing an action analysis during the use (at the time of the use) of the designated location of the location user, information for instructing an action analysis after the use of the designated location of the location user, and information for instructing a summary of results of the action analyses.

For example, the analysis unit 32 can cause the generative AI to output a summary result of the actions of the plurality of location users before and after using the designated location by including, in the prompt, instruction information for instructing a summary of the actions of the plurality of location users by classifying the actions of the plurality of location users before and after using the designated location into a plurality of groups.

For example, the analysis unit 32 can cause the generative AI to output a summary result of the actions of the plurality of location users before and after using the designated location by including, in the prompt, instruction information including information indicating an example of characteristics of the actions of the plurality of location users before and after using the designated location.

For example, the analysis unit 32 can cause the generative AI to output a summary result of the actions of the plurality of location users before and after using the designated location by including, in the prompt, instruction information including information clearly indicating characteristics to be summarized as the characteristics of the actions of the plurality of location users before and after using the designated location.

The characteristics of the actions of the location users before using the designated location are, for example, a characteristic that the location users sometimes use a specific facility or specific another store before using the designated location, a characteristic indicating a tendency of a use content in the facility or the store, a characteristic that the location user sometimes performs a specific search before using the designated location, and a characteristic indicating a tendency of a posted content thereof but are not limited to such an example.

The characteristics of the action of the location user after using the designated location are, for example, a characteristic that the location user sometimes uses a specific facility or a specific other store after using the designated location, a characteristic indicating a tendency of use content in the facility or the store, a characteristic that the location user sometimes post the designated location to an SNS after using the designated location, or a characteristic indicating a tendency of post content thereof but is not limited to such an example.

The information indicating the actions of the location users at the time of using the designated location is, for example, payment amounts and an average payment amount of the location users at the designated location, contents and genres of purchased commodities or purchased services of the location users at the designated location, and stay times and an average stay time of the location users at the designated location but is not limited to such an example.

The analysis unit 32 can also analyze an intention to use the designated location using generative AI or statistical processing. For example, the analysis unit 32 can analyze an intention to use the designated location using the generative AI by inputting, to the generative AI, a prompt including instruction information including information for instructing an analysis of the intention of use of the designated location.

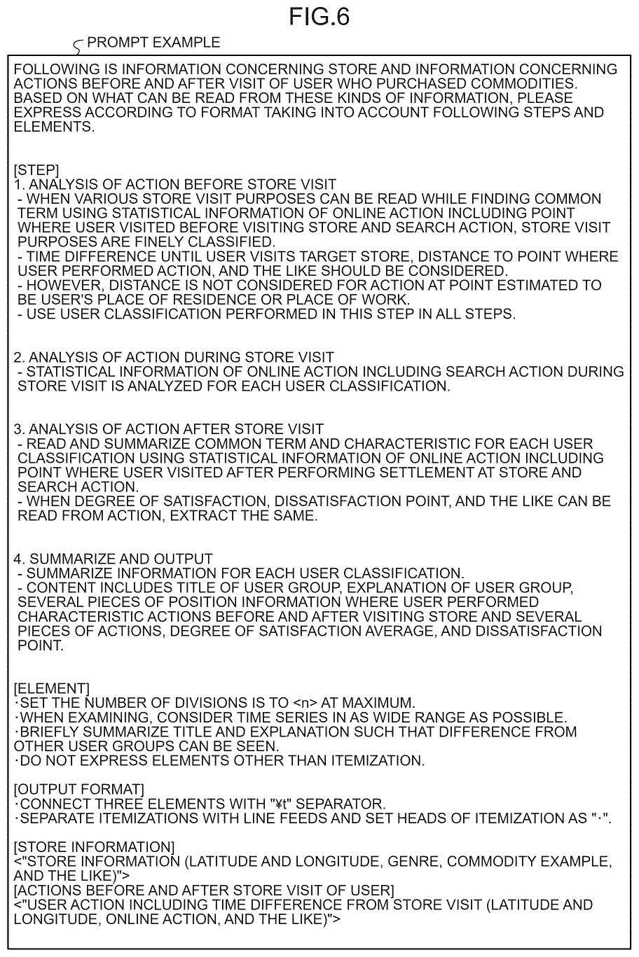

FIG. 6 is a diagram illustrating an example of a prompt used by the analysis unit 32 of the processing unit 12 in the information processing apparatus 1 according to the embodiment. For example, the analysis unit 32 inputs the prompt illustrated in FIG. 6 to the generative AI and causes the generative AI to output a summary result of the actions of the plurality of store users before and after visiting the designated store.

The prompt illustrated in FIG. 6 includes instruction information and information necessary for the summary processing. The instruction information includes, for example, information for instructing an action analysis before the store visit, information for instructing an action analysis during the store visit (at the time of the store visit), information for instructing an action analysis after the store visit, and information instructing a summary of results of the action analyses. In the example illustrated in FIG. 6, information concerning the designated store and information concerning the actions of the store users before and after visiting the store are included as the information necessary for the summary processing.

The information for instructing the action analyses includes information indicating a type of information to be used for the analyses, information for instructing classification of characteristics of actions of the store users, and information indicating points to note at the time of classification. The instruction information of the prompt illustrated in FIG. 6 includes, for example, information indicating an upper limit value of the number of classifications of the store users, information indicating a caution at the time of examination, information indicating how to summarize a title and explanation, and information indicating an expression method.

The instruction information of the prompt illustrated in FIG. 6 is information of a character string “summarize and output \n- summarize information for each user classification \n- contents are a title of a user group, explanation of the user group, several pieces of position information where characteristic actions were performed respectively before, during, and after the store visit and several actions, a satisfaction degree average, and dissatisfied points” as the information for instructing a summary of results of the action analyses.

For example, information of a character string “Connect three elements with “\t” separators, \n Separate itemizations with line feeds, and set heads of the itemizations as “⋅”.” is included as the information of the output format that defines how to output the characteristics of the actions of the plurality of store users before and after visiting the designated store but is not limited to such an example. Note that a part of the information other than the instruction information is omitted in the prompt illustrated in FIG. 6.

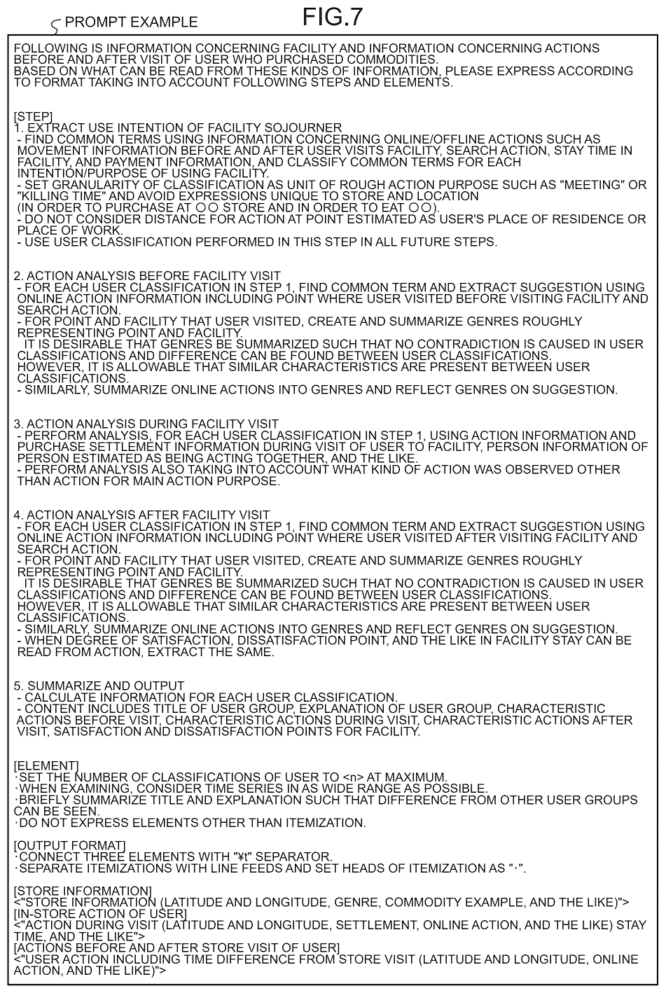

FIG. 7 is a diagram illustrating another example of the prompt used by the analysis unit 32 of the processing unit 12 in the information processing apparatus 1 according to the embodiment. For example, the analysis unit 32 inputs a prompt illustrated in FIG. 7 to the generative AI and causes the generative AI to output, taking into account the analysis of the facility use intention, a summary result of the actions of the plurality of facility users before and after visiting the designated facility.

The instruction information of the prompt illustrated in FIG. 7 includes, for example, information instructing extraction of a use intention of a facility user (a facility sojourner), information for instructing an action analysis before facility use (before facility visit), information for instructing an action analysis during the facility use (during the facility visit), and information for instructing an action analysis after the facility use (after the facility visit).

The information for instructing the extraction of the use intention of the facility user includes, for example, information indicating a type of information used for the extraction, information indicating granularity of classification of the use intention, and information indicating points to note at the time of the classification of the use intention. Accordingly, the analysis unit 32 can analyze the intention to use the designated facility using the generative AI. The same applies to the designated location.

The information for instructing the action analyses includes, for example, information indicating a type of information used for an analysis, information for instructing classification of characteristics of actions of store users, information indicating points to note at the time of the classification, and information indicating an upper limit value of the number of classifications of the store users.

The instruction information of the prompt illustrated in FIG. 7 includes, as information of an output format that defines how to output the characteristics of the actions of the plurality of relocation users before and after using the facility, information of the character string “Connect three elements with “\t” separators \n⋅ Separate itemizations with line feeds, and set heads of the itemizations are set as “⋅”. 5. Summarize and output \n- calculate information for each of user classifications \n- content includes a title of a user group, explanation of the user group, a characteristic action before visiting, a characteristic action during the visiting, a characteristic action after the visiting, and point of satisfaction/dissatisfaction with a facility” but is not limited to such an example. Note that a part of the information other than the instruction information is omitted in the prompt illustrated in FIG. 7.

The analysis unit 32 can classify the actions of the plurality of location users into two or more groups by using the classification model instead of using the generative AI. The classification model is, for example, GBDT or a neural network but is not limited to such an example.

The generative AI may be multi-modal generative AI or the like. The multi-modal generative AI is, for example, generative AI that generates at least one of text, an image, and voice from at least one of text, an image, and voice. The multi-modal generative AI is, for example, GPT-4 Turbo with vision, or gemini, CM3Leon but is not limited to such an example.

### [3.3.4. Provision Unit 33]

The provision unit 33 provides various kinds of information to the service user O. For example, the provision unit 33 provides various kinds of information to the service user O by transmitting the various kinds of information to the terminal device 2 via the communication unit 10 and the network N.

For example, when a use request is received by the reception unit 30, the provision unit 33 transmits store designation information including list information indicating a list of stores present in a designated region and map information of the designated region to the terminal device 2 to thereby provide the store designation information to the service user O.

When receiving the store designation information transmitted from the information processing apparatus 1, the terminal device 2 displays list information indicating a list of stores present in the designated region and map information of the designated region based on the received store designation information. In the list information, the stores present in the designated region are arranged in a list form to be individually designable. In the map information of the designated region, store figures indicating the positions of the stores present in the designated region are arranged to be individually designable on the map.

The service user O can designate a store set as an analysis target among a plurality of stores included in the list information displayed on the terminal device 2 and can designate a store figure corresponding to the store set as the analysis target among a plurality of store figures included in the map information displayed on the terminal device 2. When the service user O designates a store or a store figure, the terminal device 2 transmits, to the information processing apparatus 1, a summary information request including, as store information, information indicating the store designated by the service user O or information indicating a store corresponding to the store figure designated by the service user O.

When the reception unit 30 receives a summary information request, the provision unit 33 transmits provision information including the information indicating the result of the summary processing by the analysis unit 32 to the terminal device 2 to thereby provide the provision information to the service user O. The provision unit 33 provides, for example, information indicating characteristics of two or more groups classified by the analysis unit 32.

For example, the provision unit 33 provides map information indicating the result of the summary processing by the analysis unit 32 on a map to the service user O as provision information. The result of the summary processing shown on the map includes, for example, information indicating characteristics of the classified groups. For example, when the information indicating the characteristics of the groups includes information indicating points for the store users to easy to visit, in the map information provided as the provision information, information emphasizing the points for the store users to easy to visit is shown on the map in addition to the information indicating the characteristics of the groups.

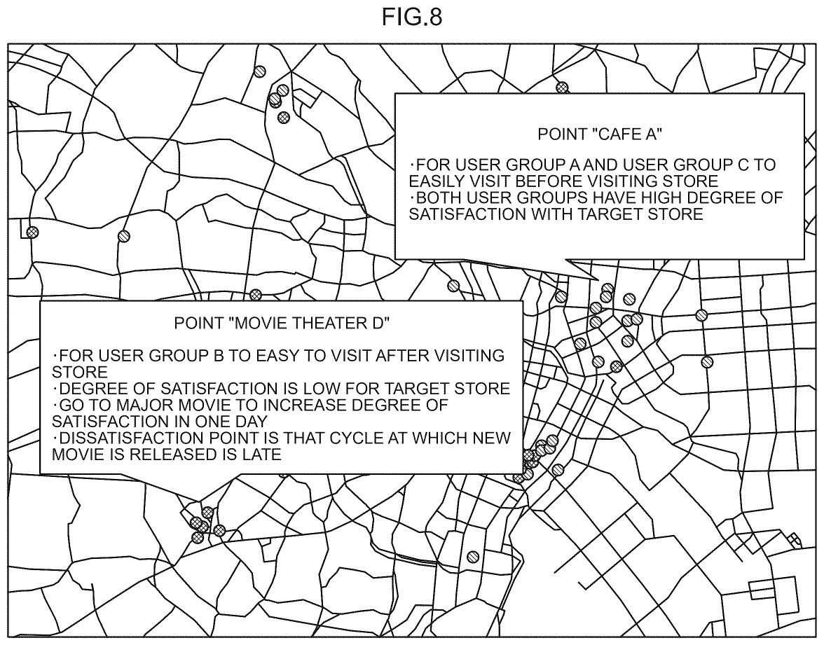

FIG. 8 is a diagram illustrating an example of map information provided by the provision unit 33 of the processing unit 12 in the information processing apparatus 1 according to the embodiment and displayed on the terminal device 2. In the example illustrated in FIG. 8, as a result of the summary processing by the analysis unit 32, information concerning the “cafe A” serving as a point for store users to easy to visit before visiting to a designated store is illustrated and information concerning the “movie theater D” serving as a point for store users to easy to visit after visiting to the designated store is illustrated.

Specifically, information of a character string “⋅ For a user group A and a user group C to easy to visit before visiting a store \n⋅ Both user groups have a high degree of satisfaction with a target store \n⋅ Look back over experience in the store with friends in a relaxed manner” is included in the provided information as the information concerning the “cafe A”. Information of a character string “⋅ For a user group B to easy to visit after visiting a store \n⋅ A degree of satisfaction is low for a target store \n⋅ Go to a major movie in order to increase a degree of satisfaction in one day \n⋅ A dissatisfaction point is that a cycle of releasing a new movie is late” is included in the provided information as the information concerning the “movie theater D”.

### [4. Processing Procedure]

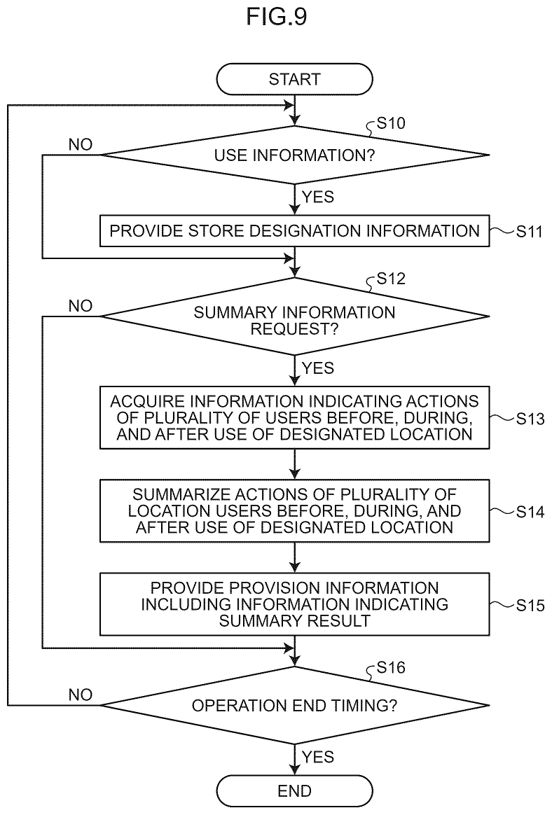

Subsequently, a procedure of information processing by the processing unit 12 of the information processing apparatus 1 according to the embodiment is explained. FIG. 9 is a flowchart illustrating an example of information processing by the processing unit 12 of the information processing apparatus 1 according to the embodiment.

As illustrated in FIG. 9, the processing unit 12 of the information processing apparatus 1 determines whether a use request from the service user O has been received (step S10). When determining that the use request from the service user O has been received (step S10: Yes), the processing unit 12 provides store designation information to the service user O (step S11).

When the processing in step S11 ends or when determining that the use request from the service user O has not been received (step S10: No), the processing unit 12 determines whether a summary information request from the service user O has been received (step S12).

When determining that the summary information request from the service user O has been received (Step S12: Yes), the processing unit 12 acquires, from the storage unit 11 or the like, information indicating actions of a plurality of users before and after using a designated location (Step S13). Then, the processing unit 12 summarizes, based on the information acquired in step S13, the actions of the plurality of location users before and after using the designated location (step S14) and provides provision information including information indicating a summary result of step S14 (step S15).

When the processing in step S15 ends or when determining that the summary information request from the service user O has not been received (step S12: No), the processing unit 12 determines whether operation end timing has come (step S16). For example, when the information processing apparatus 1 is turned off, the processing unit 12 determines that the operation end timing has come.

When determining that the operation end timing has not come (step S16: No), the processing unit 12 shifts the processing to step S10 and, when determining that the operation end timing has come (step S16: Yes), ends the processing illustrated in FIG. 9.

### [5. Modifications]

For example, in the summary processing, the analysis unit 32 can estimate moving speed of a store user before and after use of a designated location based on information indicating a position history of the store user and summarize the moving speed of the store user before and after using the designated location as a part or all of actions of the store user before and after using the designated location.

In the summary processing, the analysis unit 32 can also summarize actions of the location user before and after using the designated location for each predetermined period based on, for example, information concerning actions of the location user before and after using the designated location for each predetermined period. In this case, the provision unit 33 can also provide map information shown on a map while automatically switching, in time series, a summary result for each predetermined period estimated in estimation processing.

For example, the analysis unit 32 can also perform centralized processing by dividing the centralized processing into a plurality of kinds of processing. For example, the analysis unit 32 can perform a plurality of kinds of processing including first processing of determining characteristics of an action of a location user before using a designated location, second processing of determining characteristics of an action of the location user who is using the designated location, third processing of determining characteristics of an action of the location user after using the designated location, and fourth processing of putting together a result of the first processing, a result of the second processing, and a result of the third processing can be performed as the summary processing.

In this case, in the first processing, the analysis unit 32 inputs, to generative AI, a prompt including instruction information for instructing determination of characteristics of an action of the location user before using the designated location and information necessary for the determination of the action of the location user before using the designated location and causes the generative AI to output information indicating the characteristics of the action of the location user before using the designated location.

In the second processing, the analysis unit 32 inputs, to the generative AI, a prompt including instruction information for instructing determination of characteristics of an action of the location user who is using the designated location and information necessary for determination of the action of the location user who is using the designated location and causes the generative AI to output information indicating the characteristics of the action of the location user who is using the designated location.

In the third processing, the analysis unit 32 inputs, to the generative AI, a prompt including instruction information for instructing determination of characteristics of an action of the location user after using the designated location and information necessary for determination of the action of the location user after using the designated location and causes the generative AI to output information indicating the characteristics of the action of the location user after using the designated location.

In the fourth processing, the analysis unit 32 inputs, to the generative AI, a prompt including instruction information for instructing a summary of a result of the first processing, a result of the second processing, and a result of the third processing and information indicating the result of the first processing, the result of the second processing, and the result of the third processing and causes the generative AI to output information indicating a result summarizing the actions of the location user before, during, and after using the designated location.

In the example explained above, the reception unit 30 receives designation of one location but can also receive designation of a plurality of locations as designation of one group. In this case, the acquisition unit 31 acquires information concerning actions before, during, and after use of the plurality of locations. The analysis unit 32 can summarize the actions of the plurality of users before and after using one group based on the information concerning the actions before, during, and after using the plurality of locations. One group is, for example, a group of a plurality of stores present in a commercial facility.

### [6. Hardware Configuration]

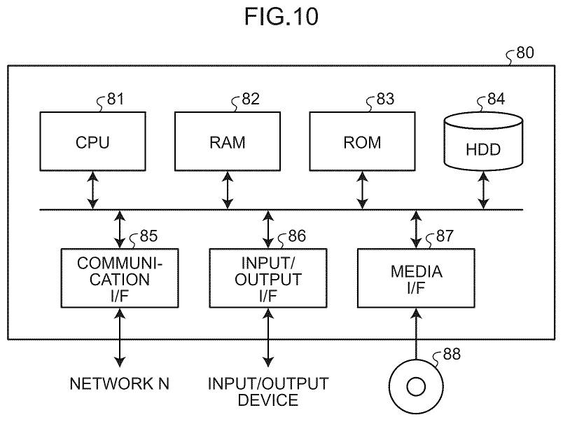

The information processing apparatus 1 according to the embodiment explained above is implemented by, for example, a computer 80 having a configuration illustrated in FIG. 10. FIG. 10 is a hardware configuration diagram illustrating an example of the computer 80 that implements the functions of the information processing apparatus 1 according to the embodiment. The computer 80 includes a CPU 81, a RAM 82, a ROM (Read Only Memory) 83, an HDD (Hard Disk Drive) 84, a communication interface (I/F) 85, an input/output interface (I/F) 86, and a media interface (I/F) 87.

The CPU 81 operates based on a program stored in the ROM 83 or the HDD 84 and controls the units. The ROM 83 stores a boot program to be executed by the CPU 81 when the computer 80 is started, a program relying on hardware of the computer 80, and the like.

The HDD 84 stores a program to be executed by the CPU 81, data to be used by the program, and the like. The communication interface 85 receives data from other devices via the network N (see FIG. 2), sends the data to the CPU 81, and transmits data generated by the CPU 81 to the other devices via the network N.

The CPU 81 controls output devices such as a display and a printer and an input device such as a keyboard or a mouse via the input/output interface 86. The CPU 81 acquires data from the input device via the input/output interface 86. The CPU 81 outputs the generated data to the output device via the input/output interface 86.

The media interface 87 reads a program or data stored in the recording medium 88 and provides the program or the data to the CPU 81 via the RAM 82. The CPU 81 loads the program from the recording medium 88 onto the RAM 82 via the media interface 87 and executes the loaded program.

The recording medium 88 is, for example, an optical recording medium such as a DVD (Digital Versatile Disc) or a PD (Phase change rewritable Disk), a magneto-optical recording medium such as an MO (Magneto-Optical disk), a tape medium, a magnetic recording medium, or a semiconductor memory.

For example, when the computer 80 functions as the information processing apparatus 1 according to the embodiment, the CPU 81 of the computer 80 implements the function of the processing unit 12 by executing the program loaded on the RAM 82. The HDD 84 stores data in the storage unit 11. The CPU 81 of the computer 80 reads these programs from the recording medium 88 and executes the programs. However, as another example, the CPU 81 may acquire these programs from another device via the network N.

### [7. Others]

Among the kinds of processing explained in the embodiment explained above, all or a part of the processing explained as being automatically performed can be manually performed or all or a part of the processing explained as being manually performed can be automatically performed by a publicly-known method. Besides, the processing procedures, the specific names, and the information including various data and parameters explained and illustrated in the document explained above and the drawings can be optionally changed except when being specifically described. For example, the various kinds of information illustrated in the figures are not limited to the illustrated information.

The components of the devices illustrated in the figures are functionally conceptual and are not always required to be physically configured as illustrated. That is, a specific form of distribution and integration of the devices is not limited to the illustrated form and all or a part of the devices can be functionally or physically distributed and integrated in any unit according to various loads, usage situations, and the like.

The configuration of the information processing apparatus 1 explained above can be flexibly changed, for example, the information processing apparatus 1 may be implemented by a terminal device and a server computer, may be implemented by a plurality of server computers, or may be implemented by calling an external platform or the like with an API, network computing, or the like depending on functions.

The embodiment and the modifications explained above can be combined as appropriate within a range that does not contradict the processing contents.

### [8. Effects]

As explained above, the information processing apparatus according to the embodiment includes the reception unit 30, the acquisition unit 31, the analysis unit 32, and the provision unit 33. The reception unit 30 receives designation of a store or a facility. The acquisition unit 31 acquires information concerning a plurality of users who have used the store or the facility, the designation of which has been received by the reception unit 30, the information indicating actions of the plurality of users before and after using the store or the facility. The analysis unit 32 summarizes, based on the information indicating the actions of the plurality of users before and after using the store or the facility acquired by the acquisition unit 31, the actions of the plurality of users before and after using the store or the facility. The provision unit 33 provides a summary result by the analysis unit 32. Accordingly, the information processing apparatus 1 can support an analysis of the users of the store or the facility.

The acquisition unit 31 further acquires information concerning the plurality of users who have used the store or the facility, the information indicating actions of the plurality of users at the time of using the store or the facility. The analysis unit 32 summarizes the actions of the plurality of users before, during, and after using the store or the facility based on the information indicating the actions of the plurality of users before and after using the store or the facility and the information indicating the actions of the plurality of users at the time of using the store or the facility acquired by the acquisition unit 31. Accordingly, the information processing apparatus 1 can further support the analysis of the users of the store or the facility.

The analysis unit 32 summarizes the actions of the plurality of users by classifying the actions of the plurality of users into two or more groups. Accordingly, the information processing apparatus 1 can further support the analysis of the users of the store or the facility.

The provision unit 33 provides information indicating characteristics of the two or more groups classified by the analysis unit 32. Accordingly, the information processing apparatus 1 can further support the analysis of the users of the store or the facility.

The analysis unit 32 analyzes an intention to use the store or the facility. Accordingly, the information processing apparatus 1 can further support the analysis of the users of the store or the facility.

The analysis unit 32 summarizes the actions of the plurality of users using the generative AI. Accordingly, the information processing apparatus 1 can further support the analysis of the users of the store or the facility.

The information indicating the actions includes information indicating an online action and information indicating an offline action. Accordingly, the information processing apparatus 1 can further support the analysis of the users of the store or the facility.

The analysis unit 32 determines evaluations of the plurality of users for the store or the facility. Accordingly, the information processing apparatus 1 can further support the analysis of the users of the store or the facility.

Although the embodiment of the present application is explained above in detail with reference to the drawings, this is merely exemplification, and the present invention can be implemented in other forms to which various modifications and improvements are applied based on the knowledge of those skilled in the art, including the aspects described in the disclosure of the invention.

The “section, module, and unit” explained above can be replaced with “means”, “circuit”, and the like. For example, the acquisition unit can be replaced with acquiring means or an acquisition circuit.

What is claimed is:

1. An information processing apparatus comprising:
a reception unit configured to receive designation of a store or a facility;
an acquisition unit configured to acquire information concerning a plurality of users who have used the store or the facility, the designation of which has been received by the reception unit, the information indicating actions of the plurality of users before and after using the store or the facility;
an analysis unit configured to summarize, based on the information indicating the actions of the plurality of users before and after using the store or the facility acquired by the acquisition unit, the actions of the plurality of users before and after using the store or the facility; and
a provision unit configured to provide a summary result by the analysis unit.

2. The information processing apparatus according to claim 1, wherein
the acquisition unit further acquires information concerning the plurality of users who have used the store or the facility, the information indicating actions of the plurality of users at a time of using the store or the facility, and
the analysis unit summarizes, based on the information indicating the actions of the plurality of users before and after using the store or the facility and the information indicating the actions of the plurality of users during the use of the store or the facility acquired by the acquisition unit, the action of the plurality of users before, during, and after using the store or the facility.

3. The information processing apparatus according to claim 2, wherein
the analysis unit summarizes the actions of the plurality of users by classifying the actions of the plurality of users into two or more groups.

4. The information processing apparatus according to claim 3, wherein
the provision unit provides information indicating characteristics of the two or more groups classified by the analysis unit.

5. The information processing apparatus according to claim 4, wherein
the analysis unit analyzes an intention to use of the store or the facility.

6. The information processing apparatus according to claim 1, wherein
the analysis unit summarizes the actions of the plurality of users using generative AI.

7. The information processing apparatus according to claim 1, wherein
the information indicating the actions includes information indicating an online action and information indicating an offline action.

8. The information processing apparatus according to claim 1, wherein
the analysis unit determines evaluations of the plurality of users for the store or the facility.

9. An information processing method executed by a computer, the method comprising:
a receiving step of receiving designation of a store or a facility;
an acquiring step of acquiring information concerning a plurality of users who have used the store or the facility, the designation of which has been received in the receiving step, the information indicating actions of the plurality of users before and after using the store or the facility;
an analyzing step of summarizing the actions of the plurality of users before and after using the store or the facility based on the information indicating the actions of the plurality of users before and after using the store or the facility acquired in the acquiring step; and
a providing step of providing a summary result by the analyzing step.

10. A non-transitory computer-readable storage medium storing an information processing program for causing a computer to execute:
a receiving procedure of receiving designation of a store or a facility;
an acquiring procedure of acquiring information concerning a plurality of users who have used the store or the facility, the designation of which has been received in the receiving procedure, the information indicating actions of the plurality of users before and after using the store or the facility;
an analyzing procedure of summarizing the actions of the plurality of users before and after using the store or the facility based on the information indicating the actions of the plurality of users before and after using the store or the facility acquired by the acquiring procedure; and
a providing procedure of providing a summary result by the analyzing procedure.
